(19) United States
(12) Patent Application Publication
(10) Pub. No.: US 2005/0253937 A1
(43) Pub. Date: Nov. 17, 2005

(54) Real-time exposure control for automatic light control

(75) Inventors: Jorgen Moholt, Moss (NO); Steinar Iversen, Oslo (NO)

Correspondence Address: DICKSTEIN SHAPIRO MORIN & OSHINSKY LLP, 2101 L Street, NW, Washington, DC, 20037, US

(73) Assignee: MICRON TECHNOLOGY, INC.

(21) Appl. No.: 11/052,217

(22) Filed: Feb. 8, 2005

Related U.S. Application Data
(63) Continuation-in-part of application No. 10/846,513, filed on May 17, 2004.

(51) Int. Cl. H04N 5/235

(52) U.S. Cl. 348/229.1

(57) ABSTRACT

An imager and a method for real-time, non-destructive monitoring of light incident on imager pixels during their exposure to light. Real-time or present pixel signals, which are indicative of present illumination on the pixels, are compared to a reference signal during the exposure. Adjustments, if necessary, are made to programmable parameters such as gain and/or exposure time to automatically control the imager's exposure to the light. In a preferred exemplary embodiment, only a selected number of pixels are monitored for exposure control as opposed to monitoring the entire pixel array. Digital feedback may be used to adjust the automatic light control process so that it accounts for potential inaccuracies in the light control process.

The present application is a continuation-in-part of application Ser. No. 10/846,513, filed on May 17, 2004, which is hereby incorporated by reference in its entirety.

### FIELD OF THE INVENTION

The invention relates generally to imaging devices and more particularly to real-time exposure control for automatic light control in an imaging device.

### BACKGROUND

A CMOS imager circuit includes a focal plane array of pixel cells, each one of the cells including a photosensor, for example, a photogate, photoconductor or a photodiode overlying a substrate for accumulating photo-generated charge in the underlying portion of the substrate. Each pixel cell has a readout circuit that includes at least an output field effect transistor formed in the substrate and a charge storage region formed on the substrate connected to the gate of an output transistor. The charge storage region may be constructed as a floating diffusion region. Each pixel may include at least one electronic device such as a transistor for transferring charge from the photosensor to the storage region and one device, also typically a transistor, for resetting the storage region to a predetermined charge level prior to charge transference.

In a CMOS imager, the active elements of a pixel cell perform the necessary functions of: (1) photon to charge conversion; (2) accumulation of image charge; (3) resetting the storage region to a known state; (4) selection of a pixel for readout; and (5) output and amplification of a signal representing pixel charge. The charge at the storage region is typically converted to a pixel output voltage by the capacitance of the storage region and a source follower output transistor.

CMOS imagers of the type discussed above are generally known as discussed, for example, in U.S. Pat. No. 6,140,630, U.S. Pat. No. 6,376,868, U.S. Pat. No. 6,310,366, U.S. Pat. No. 6,326,652, U.S. Pat. No. 6,204,524 and U.S. Pat. No. 6,333,205, assigned to Micron Technology, Inc., which are hereby incorporated by reference in their entirety.

FIG. 1 illustrates a block diagram for a CMOS imager 10. The imager 10 includes a pixel array 20. The pixel array 20 comprises a plurality of pixels arranged in a predetermined number of columns and rows. The pixels of each row in array 20 are all turned on at the same time by a row select line and the pixels of each column are selectively output by a column select line. A plurality of row and column lines are provided for the entire array 20.

The row lines are selectively activated by the row driver 32 in response to row address decoder 30 and the column select lines are selectively activated by the column driver 36 in response to column address decoder 34. Thus, a row and column address is provided for each pixel. The CMOS imager 10 is operated by the control circuit 40, which controls address decoders 30, 34 for selecting the appropriate row and column lines for pixel readout, and row and column driver circuitry 32, 36, which apply driving voltage to the drive transistors of the selected row and column lines.

Each column contains sampling capacitors and switches 38 associated with the column driver 36 reads a pixel reset signal Vᵣₛₜ and a pixel image signal V_{sig} for selected pixels. A differential signal (Vᵣₛₜ−V_{sig}) is produced by differential amplifier 40 for each pixel and is digitized by analog-to-digital converter 45 (ADC). The analog-to-digital converter 45 supplies the digitized pixel signals to an image processor 50, which forms a digital image output.

Lighting can effect image exposure. Light conditions may change spatially and over time. Thus, automatic light control is required to ensure that the best image is obtained by controlling the image sensor's exposure to the light. In some imager applications, there is a need to use the illumination during the actual exposure of an image (i.e., “present illumination”) to control the exposure (i.e., perform exposure control). That is, there is a need to use present illumination because the use of the previous picture's illumination may not be sufficient for the intended application.

One exemplary application that would benefit from using present illumination in exposure control is the imager in a swallowable pill application, such as the one described in copending U.S. application Ser. No. 10/143,578, the disclosure of which is incorporated herein by reference. Due to the nature of the imager in a pill application, automatic light control using present illumination is required. A proposed solution would be to light the application's light source (e.g., light emitting diodes) prior to the actual exposure periods. This technique, however, creates an undesirable high waste of energy and power by having the light source on longer than the exposure period.

Accordingly, there is a desire and need for automatic light control during an exposure period that uses present illumination, yet does not unnecessarily waste energy or power in the process.

### SUMMARY

The invention provides automatic light control during an exposure period using present illumination.

The invention also provides a mechanism for adjusting the automatic light control process by accounting for potential inaccuracies in the process.

Various exemplary embodiments of the invention provide an imager and a method for real-time, non-destructive monitoring of light incident on imager pixels during their exposure to light. Real-time or present pixel signals, which are indicative of present illumination on the pixels, are compared to a reference signal during the exposure. Adjustments, if necessary, are made to programmable parameters such as gain and/or exposure time to automatically control the imager's exposure to the light. In a preferred exemplary embodiment, only a selected number of pixels are monitored for exposure control as opposed to monitoring the entire pixel array. In another preferred exemplary embodiment, digital feedback is used to adjust the automatic light control process such that it accounts for potential inaccuracies in the light control process.

### BRIEF DESCRIPTION OF THE DRAWINGS

The foregoing and other advantages and features of the invention will become more apparent from the detailed description of exemplary embodiments provided below with reference to the accompanying drawings in which:

FIG. 1 illustrates a block diagram for a CMOS imager;

FIG. 2 illustrates a block diagram of an exemplary imager light control function constructed in accordance with an embodiment of the invention;

FIG. 3 illustrates in flowchart form an exemplary method of performing automatic light control in accordance with an embodiment of the invention;

FIG. 4 illustrates a graph of gain settings and pixel output levels versus time according to an operation of the invention;

FIG. 5 illustrates in schematic form an exemplary embodiment of a voltage reference generator according to the invention;

FIG. 6 illustrates another exemplary imager constructed in accordance with another embodiment of the invention;

FIG. 7 shows a processor system incorporating at least one imaging device constructed in accordance with an embodiment of the invention;

FIG. 8 shows another exemplary system incorporating at least one imaging device constructed in accordance with another embodiment of the invention;

FIG. 9 illustrates another exemplary imager constructed in accordance with another embodiment of the invention, the imager utilizing digital feedback to adjust the automatic light control process of the invention;

FIG. 10 is an illustration of the concept of using digital feedback to adjust the automatic light control process of the invention;

FIG. 11 illustrates another exemplary imager constructed in accordance with another embodiment of the invention, the imager utilizing digital feedback to adjust the automatic light control process of the invention; and

FIG. 12 illustrates a four transistor imager pixel cell.

### DETAILED DESCRIPTION

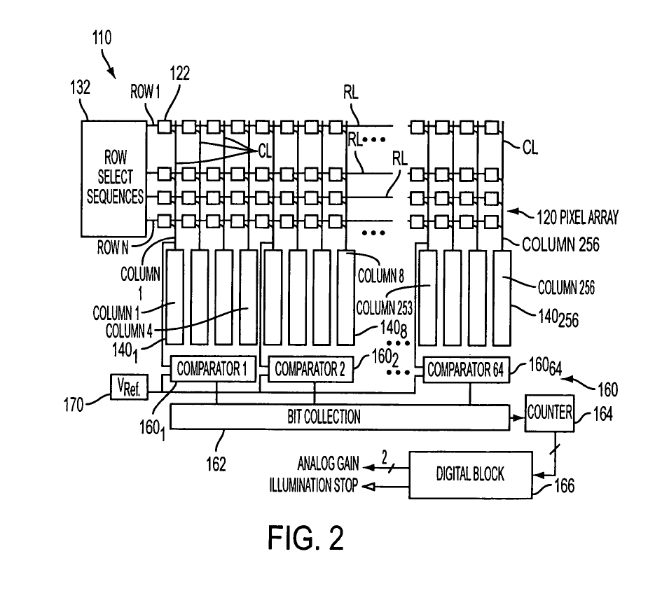

Referring to the figures, where like reference numbers designate like elements, FIG. 2 shows a portion of an exemplary imager 110 containing a light control function constructed in accordance with an embodiment of the invention. The imager 110 includes a pixel array 120 containing a plurality of pixels 122 organized in rows ROW₁, . . . , ROW_{N} and columns COLUMN₁, . . . , COLUMN₂₅₆. A plurality of row lines RL and column lines CL are provided for the entire array 20. Pixels 122 in a same row e.g., ROW₁ are connected to row selection circuitry 132 by respective row lines RL. Pixels 122 in a same column COLUMN₁, . . . , COLUMN₂₅₆ are connected by a respective column line CL to a dedicated sampling capacitors and switches 140₁, . . . , 140₂₅₆ (collectively “sampling capacitors and switches 140”) for that column COLUMN₁, . . . , COLUMN₂₅₆.

The imager 110 also includes a plurality of comparators 160₁, . . . , 160₆₄ (collectively “comparators 160”). In the illustrated embodiment, there are sixty-four comparators 160, one for every four columns of the pixel array 120. As is discussed below in more detail, the invention is not limited to a specific number of comparators 160. For the illustrated embodiment, the inventors have determined that sixty-four comparators 160, connected to sixty-four different columns is desirable. In the illustrated embodiment, the first comparator 1601 is connected to the column line CL of the first column COLUMN₁, the second comparator 160₂ is connected to the column line CL of the fifth column, etc. The last comparator 160₆₄ is connected to the column line CL of the 253rd column COLUMN₂₅₃.

In operation, the rows are selected in sequence. A “scan” as used herein is a sequence of consecutive row selections. When a predefined row e.g., ROW₁ in the array 120 is selected, the comparators 160 are connected to the set of pixels 122 in the dedicated columns e.g., COLUMN₁, COLUMN₅, . . . , COLUMN₂₅₃. The comparators 160 receive pixel signals from their respective column lines CL. The pixel signals, as is discussed below in more detail, are used to determine the present illumination of the pixels 122 of the respective columns.

The comparators 160 are also connected to a voltage reference generator 170 that outputs a reference voltage V_{ref} to be compared against the pixels signals. As is discussed below, the voltage reference generator 170 is controllable to output different reference voltages V_{ref} when desired. Each comparator 160 outputs one logic value (e.g., logical “1”) when its respective pixel signal exceeds the reference voltage V_{ref} and a second different logical value (e.g., logical “0”) when its respective pixel signal has not exceeded the reference voltages V_{ref}.

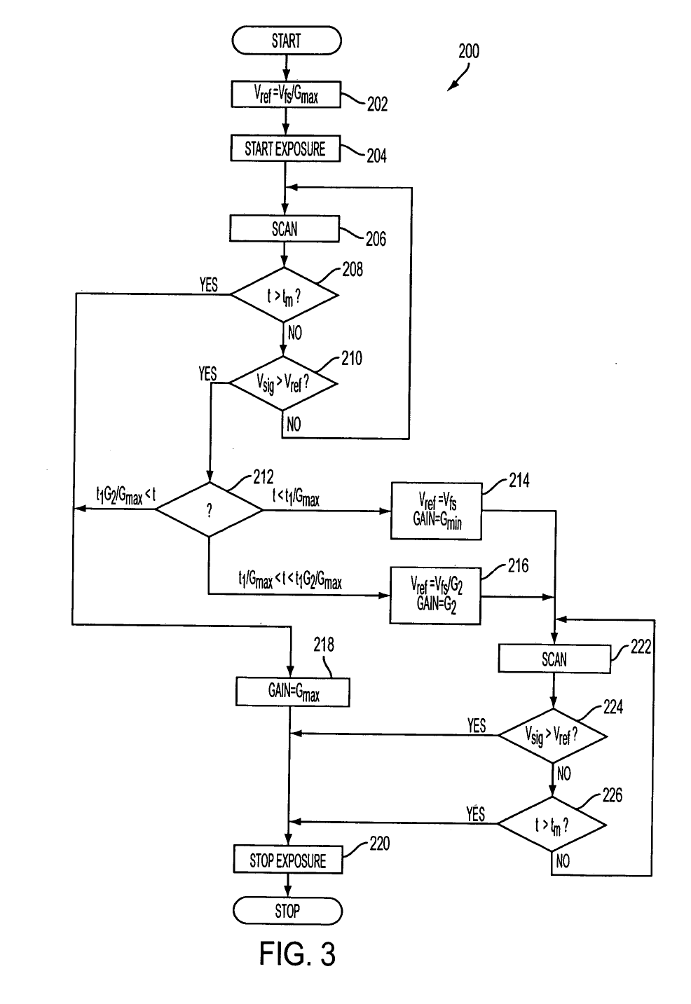

A bit collection circuit 162 is used to collect the results of the comparators 160 and to output the results to a counter 164. The counter 164 counts the number of pixels that have exceeded the reference voltage V_{ref} in a single scan (e.g., the predetermined number of consecutively selected rows). The output of the counter 164 is used by a digital logic block 166 and compared to a predetermined number of pixels in the block 166. Depending upon the comparison, as is explained below in more detail with respect to FIG. 3, the digital block 166 may output an analog gain value ANALOG GAIN and/or an illumination stop signal ILLUMINATION STOP. The analog gain value ANALOG GAIN is used during pixel readout to ensure that the appropriate signal strength is used during the readout process. The illumination stop signal ILLUMINATION STOP is used to end the exposure period for all of the pixels 122 in the array 120 (i.e., stop the exposure of light onto the pixels 122).

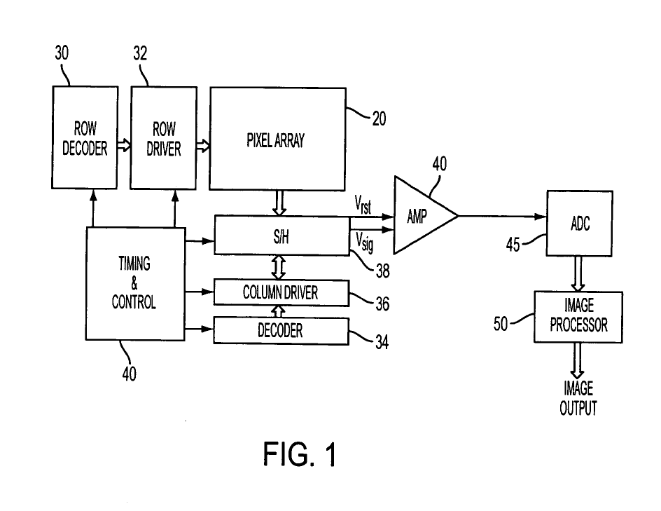

Although not shown, the imager 110 also includes a differential amplifier (e.g., amplifier 40 of FIG. 1), an analog-to-digital converter (e.g., ADC 45 of FIG. 1) and an image processor (e.g., processor 50 of FIG. 1). As described above with reference to FIG. 1, the sample and hold circuit samples and holds pixel reset Vrst and a pixel image signals Vsig for selected pixels. The differential amplifier produces a differential signal (Vrst-Vsig) for each pixel, which is digitized by the analog-to-digital converter The digitized pixel signals are input by the image processor and output as a digital image.

The illustrated imager 110 also performs automatic light control according to an embodiment of the invention. FIG. 3 illustrates an exemplary method 200 of performing automatic light control in accordance with an embodiment of the invention. The method 200 has some desirable requirements that enable it to achieve automatic light control in a quick, efficient, real-time and non-destructive manner.

For example, method 200 uses a measurement time that is part of and no greater than the total exposure time. Keeping the measurement time within the boundaries of the total exposure helps conserve power. Another desirable requirement is that the measurements taken during execution of method 200 are performed on a subset of pixels, rather than the entire array. The measurements are non-destructive, which means that the pixels are not reset during the exposure.

The method 200 seeks to obtain a predefined number of pixels having a predefined signal level (discussed in more detail below). To ensure a fast light control process, method 200 uses analog pixel signals rather than using analog-to-digital converted pixel signals. The method 200 will not include pixels having “white spots” (i.e., pixels with defects or extremely high dark current) in its final light control determination. The method 200 uses programmable (i.e., adjustable parameters) such as e.g., the analog gain required during pixel readout, required number of pixels at the predefined signal level (“Pᵣ”), preferred exposure time (“t₁”) and maximum exposure time (“tₘ”). “Exposure time” is the time the light source is illuminated.

As will become apparent, method 200 continuously scans the predefined pixels during the exposure period. Decisions on the readout gain and exposure time settings are made based on the time intervals when the required number of pixels Pᵣ reach the reference level V_{ref} (if they reach the level at all). Adjustments to certain parameters, including the reference level V_{ref}, maximum exposure time tₘ and gain, may be made during the exposure period.

Before execution of method 200 begins, the required number of pixels at the predefined signal level Pᵣ must be set. In addition, the preferred exposure time t₁ and maximum exposure time tₘ must also be set. The values for the required number of pixels Pᵣ, preferred exposure time t₁ and maximum exposure time tₘ are application specific and the invention is not to be limited to any specific values for these parameters. The maximum exposure time tₘ limits the exposure duration to prevent blurring of the images. As will become apparent, the timing values used to determine changes in the reference level (V_{ref}) and gain are determined based on the preferred exposure time t₁.

Execution of method 200 begins by setting the reference level V_{ref} (step 202). In a desired embodiment, V_{ref} is set to V_{fs}/Gₘₐₓ, where V_{fs} is the full scale signal and Gₘₐₓ is the maximum gain that can be used. An exemplary value for V_{fs} is 1V and an exemplary value for Gₘₐₓ is 4. Once the reference level V_{ref} is set, the exposure is started and the current exposure time t is set to 0 (step 204). It should be noted that how the exposure is started is application specific. For example, in a swallowable pill application, or any application with its own light source, the exposure is started by turning on the light source. For other applications where the light is continuous, the exposure period is the integration period. As such, the start of the exposure period is the start of the integration period (which could be activated by a shutter or some other method known in the art).

All of the predefined pixels are scanned (step 206) during an exposure (or integration period). The pixel signals V_{sig} from all the predefined scanned pixels are sent via a respective column line to a respective comparator. Once all of the pixels are scanned, the present time t is compared to the maximum exposure time tₘ (step 208). If the present time t is greater than the maximum exposure time tₘ, the method continues at step 218 where the gain is set to maximum gain Gₘₐₓ. The exposure is stopped (i.e., the digital block 166 of FIG. 2 outputs the illumination stop signal ILLUMINATION STOP to turn off the illumination devices or to end the integration period, depending upon the application)(step 220) and the method 200 ends.

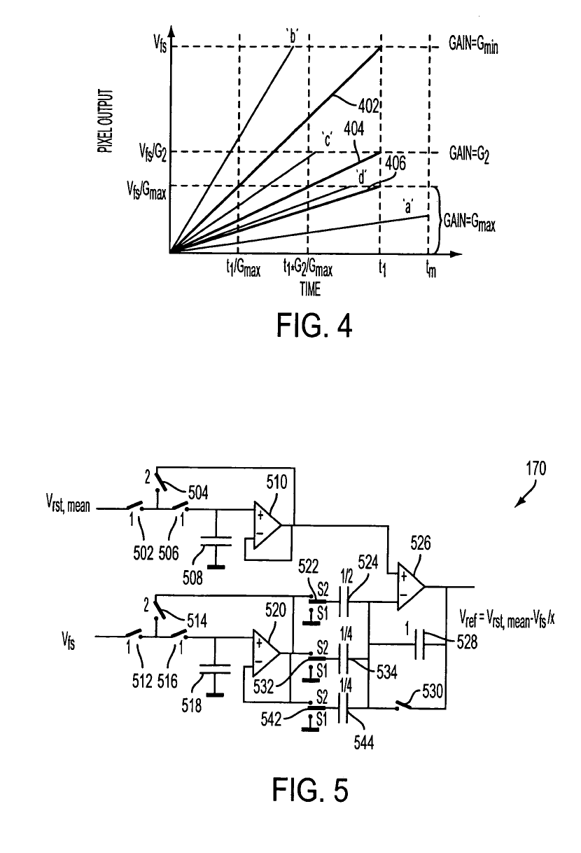

The new gain setting is reflected as line ‘a’ in FIG. 4, which is a graph of gain settings and pixel output level versus time. In FIG. 4, solid lines 402, 404 and 406 reflect respective gain limits for the various pixel output versus time combinations. Specifically, line 402 reflects the gain limit set to the minimum gain Gₘᵢₙ, line 404 represents the gain limit G₂ (a gain halfway between the maximum and minimum) and line 406 reflects the gain limit set to the minimum gain Gₘₐₓ.

Referring again to FIG. 3, if at step 208 the present time t is not greater than the maximum exposure time tₘ, the method continues at step 210 where, for each predefined pixel, each comparator determines if the pixel signal V_{sig} is greater than the reference level V_{ref}. If a required number of pixels Pᵣ of the predefined number of pixels do not have a pixel signal V_{sig} that is greater than the reference level V_{ref} (step 210), the method 200 continues at step 206 where all of the predefined pixels are scanned once again.

If the required number of pixels Pᵣ of the predefined number of pixels have a pixel signal V_{sig} that is greater than the reference level V_{ref} (step 210) the method 200 continues at step 212 to determine the appropriate light control action.

If the present time t is less than t₁/Gₘₐₓ, the readout gain is set to the minimum gain Gₘᵢₙ and the reference level V_{ref} is set to V_{fs} (step 214). The new gain setting is reflected as line ‘b’ in FIG. 4. The exposure is allowed to continue. As such, the method 200 continues at step 222 where all of the predefined pixels are scanned again. At step 224 it is determined, for each predefined pixel, if the pixel signal V_{sig} is greater than the new reference level V_{ref}. If a required number of pixels Pᵣ of the predefined number of pixels do not have a pixel signal V_{sig} that is greater than the reference level V_{ref} (step 224), the method 200 continues at step 226 to determine if the present time t is greater than the maximum exposure time tₘ.

If it is determined that the present time t is not greater than the maximum exposure time tₘ, the method 200 continues at step 222. If it is determined that the present time t is greater than the maximum exposure time tₘ (step 226) or that required number of pixels Pᵣ have a pixel signal V_{sig} that is greater than the reference level V_{ref} (step 224), the exposure is stopped (step 220) and the method 200 terminates.

If at step 212 it is determined that t1/Gmax<t<t1G2/Gmax, the readout gain is set to G2 (i.e., the gain halfway between the maximum and minimum gains), the reference level Vref is set to Vfs/G2 (step 216), and the exposure is allowed to continue. As such, the method 200 continues at step 222 where all of the predefined pixels are scanned again (as discussed above). The new gain setting is reflected as line ‘c’ in FIG. 4.

If at step 212 it is determined that t₁G₂/Gₘₐₓ<t, the readout gain is set to the maximum gain Gₘₐₓ (step 218) and the exposure is stopped (step 220). The new gain setting is reflected as line ‘d’ in FIG. 4.

Thus, the illumination on the pixels is monitored in real-time, with adjustments to exposure time duration and readout gain (if necessary). Present illumination on the pixels is determined in a non-destructive manner. That is, the signal level of the pixels is not altered or effected in any manner so that the eventual digital image reflects the image captured by the pixels. The method 200 conserves power by only utilizing the light source during the exposure period (as opposed to illuminating the light source prior to and longer than the exposure period).

In method 200, the rows are scanned sequentially, but the invention is not so limited. The columns are checked in parallel by comparing the pixel signals to the reference level in the comparators 160 (FIG. 2).

For CMOS image sensors, the pixel is typically reset before the exposure. As such, the pixel signal output level Vₒᵤₜ begins at the reset voltage Vᵣₛₜ. When exposed to light, the pixel output signal level (in absolute voltage) gradually drops toward a ground potential during the integration/exposure period. Thus, the pixel signal V_{sig} is usually defined as V_{sig}=Vᵣₛₜ−Vₒᵤₜ. The defined threshold level Vₜₕ is usually defined as Vₜₕ=Vᵣₛₜ−Vₚᵢₓ₋ₜₕ, where Vₚᵢₓ₋ₜₕ is the pixel threshold referred to ground.

The reference voltage presented to the comparators is the voltage (referred to ground) that represents the pixel output voltage Vₚᵢₓ₋ₜₕ (referred to ground) at the desired signal level Vₜₕ (referred to reset level). V_{sig} is Vᵣₛₜ minus the pixel output level at any time, thus Vₜₕ=Vᵣₛₜ−Vₚᵢₓ₋ₜₕ. During processing, the reference level V_{ref} is V_{fs}/gain, ideally referenced against Vᵣₛₜ. Vᵣₛₜ, however, is not available during the exposure. As such, an average reset level V_{rst,mean} is used during the exposure period. V_{rst,mean} is the average reset level from a set of dark (i.e., light shielded) pixels outside or at the border of the image area. The pixel signal level is given as the difference between the pixel reset level and the instantaneous pixel output voltage, and will this be a positive voltage increasing from 0 during exposure.

During method 200, the results of the first scan of the predetermined pixels (which in the illustrated embodiment is 640 pixels) is used as a check for “white spots.” These pixels are not allowed to contribute to the light control determinations effecting gain and exposure time settings. The method 200 may be modified to scan additional pixels to compensate for the “white spot” pixels. In addition, method 200 may include the option to check for a predetermined number of saturated pixels after each scanned line, or at other intervals based on selected rows, to terminate the scan before it completes. This option increases the exposure time resolution.

The supply voltage in the exposure period may be different from the supply voltage during pixel readout. This means that the pixel reset level may not be correct during exposure. The voltage reference generator 170 according to the invention (FIG. 5) compensates for this. The generator 170 includes several sample and hold switches 502, 504, 506, 512, 514, 516, capacitors 508, 518, 524, 528, 534, 544, three amplifiers 510, 520, 526 and additional switches S1, S2.

In the illustrated generator 170, a mean reset value V_{rst,mean} from a set of dummy pixels is sampled and stored on capacitor 508 just before the light is illuminated (or the integration period begins). A low droop rate is required as the reset level V_{rst,mean} must be valid throughout the complete light control method 200. To reduce leakage, the sampled value V_{rst,mean} is buffered in amplifier 510 and feedback to the switch 506 terminal and to the first sampling capacitor 508. The full scale level V_{fs} is sampled from a supply voltage source in an identical manner and a switched capacitor circuit (i.e., capacitors 524, 534, 544 and switches S1, S2) generates the reference V_{ref} sent to the comparators. That is, V_{ref}=V_{rst,mean}−V_{fs}/x, where x=gain.

In the illustrated embodiment of the generator 170, the generation of the reference Vref is done by subtraction of the predefined fraction of the full scale signal Vfs from the average reset level Vrst,mean. It should be noted that the generation of the reference Vref may be based on addition or multiplication of currents and the invention is not to be limited to the subtraction technique illustrated in FIG. 5. Vfs is divided by the readout gains 1, 2, or 4 according to the position of the switches S1, S2. The value is buffered by the third amplifier 566, which has its reference terminal connected to the Vrst,mean signal. Then, Vfs/x, where x=gain, becomes relative to Vrst,mean and the output becomes Vrst,mean−Vfs/x relative to ground, which is desirable.

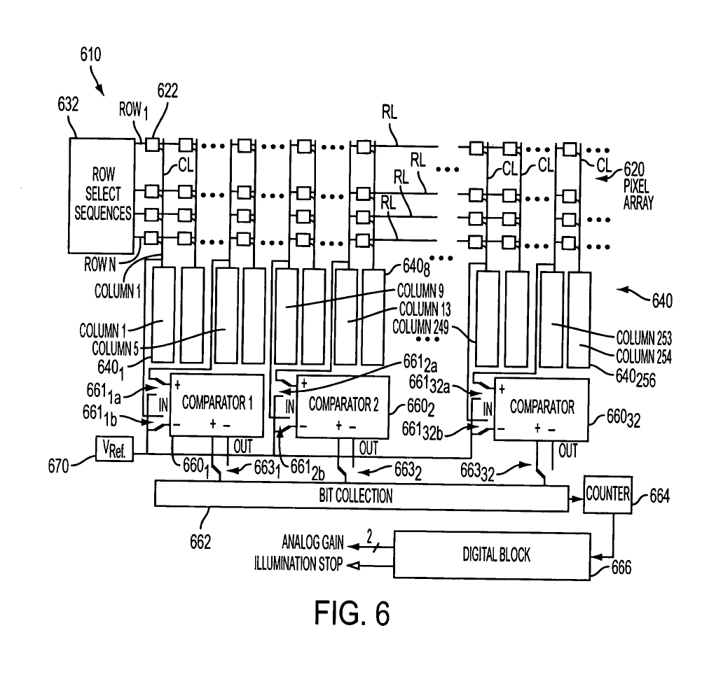

FIG. 6 illustrates another exemplary imager 610 constructed in accordance with another exemplary embodiment of the invention. The illustrated imager 610 compensates for comparator input offsets, which may be present in the imager 110 illustrated in FIG. 2. The illustrated imager 610 uses half the number of comparators 660₁, 660₂, . . . , 660₃₂ that are used in the FIG. 2 imager 110. The illustrated imager 610 compares columns in two consecutive phases. In phase one, the outputs from the first half of the columns (e.g., column 1, column 9, . . . , column 249) are input into the comparators 660₁, 660₂, . . . , 660₃₂ via input switches 661₁ₐ, 661₂ₐ, . . . , 661₃₂ₐ and tested against the reference level V_{ref} via input switches 661_{1b}, 661_{2b}, . . . , 661_{32b}. The results are output from the comparators 660₁, 660₂, . . . , 660₃₂ to the bit collection unit 662 via switch 663₁, 663₂, . . . , 663₃₂. In the second phase, the outputs from the second half of the columns (e.g., column 5, column 13, . . . , column 253) are input into the comparators 660₁, 660₂, . . . , 660₃₂ via input switches 661_{1b}, 661_{2b}, . . . , 661_{32b} and tested against the reference level V_{ref} via input switches 661₁ₐ, 661₂ₐ, . . . , 661₃₂ₐ. The results are output from an inverted output of the comparators 660₁, 660₂, . . . , 660₃₂ to the bit collection unit 662 via switches 663₁, 663₂, . . . , 663₃₂.

Using swapped input and output terminals of the comparators 660₁, 660₂, . . . , 660₃₂, potential offsets are substantially removed from the light control process. This improves the accuracy of the light control process of the invention.

The automatic light control methods (e.g., method 200) described above scan a selected number of rows of pixels. In general, the criteria for stopping the exposure is when a certain number of the selected automatic light control subset of pixels (sometimes referred to herein as the “ALC pixels”) have reached a predetermined signal level (e.g., V_{ref} set by e.g., a digital register). When the entire frame is readout after the exposure has stopped, however, the number of pixels that have actually reached the predetermined signal level may be different due to inaccuracies in the process. For example, there are two branches at the pixel output (from the column lines CL): one path to the ALC circuitry and another to the analog-to-digital converter circuitry. Since there are these two paths, uncertainty in the pixel reset level, ADC full scale level V_{fs}, offsets in the comparators and voltage reference generator, and finite time resolution may all lead to inaccuracies within the ALC process. Any inaccuracy (or uncertainty) may lead to either a too short or too long exposure time, which is undesirable.

It is possible to automatically calculate the inaccuracy of the ALC process and compensate for the inaccuracy before the next scan in the process. As is described below in more detail, the present invention will utilize digital feedback to the voltage reference generator (e.g., voltage reference generator 170 of FIG. 2, voltage reference generator 670 of FIG. 6) to compensate for any inaccuracy in the process by raising or lowering the reference voltage Vref as required. In general, the present invention will check the actual bit values of the selected predefined set of ALC pixels (discussed above with respect to method 200) during frame readout to see how many of the pixels actually reached the predefined signal level (e.g., Vref). This number of pixels is then compared to a predefined required number (which can also be the required number of pixels at the predefined signal level Pr discussed above with respect to method 200). Digital feedback (based on this comparison) is then used to adjust the ALC method (described below in more detail).

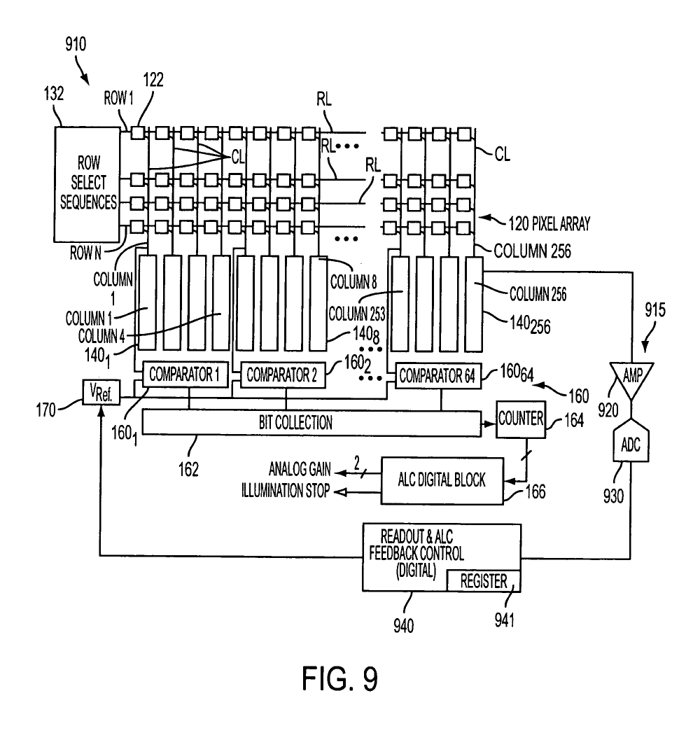

FIG. 9 illustrates another exemplary imager 910 constructed in accordance with another embodiment of the invention. The illustrated imager 910 utilizes digital feedback to adjust the automatic light control method of the invention. The illustrated imager 910 is essentially the same as the imager 110 illustrated in FIG. 2 except that a digital readout and ALC feedback control block 940 is connected to an analog-to-digital converter 930. The imager 910 also includes an amplifier 920 connected to the column circuitry 140. It should be noted that the analog-to-digital converter 930 and the amplifier 920 are the same as those illustrated in FIG. 1.

Although only one amplifier 920 and analog-to-digital converter 930 are shown in FIG. 9, it should be appreciated that there will be multiple amplifiers 920 and ADCs 930 in the imager 910. In a desired embodiment, there is one amplifier 920 and one ADC 930 per column. In another embodiment, there are two or more amplifiers 920 and ADCs 930 per column (with appropriate switching/multiplexing circuitry). The amplifiers 920 and analog-to-digital converters 930 comprise an analog-to-digital converter path 915 that feeds into the digital readout and ALC feedback control block 940.

As will become apparent from the following description, the implementation of the automatic light control feedback adjustment to method 200 is purely digital. With this digital implementation there is a register 941 (shown as part of the readout and ALC feedback control logic 940) where a user can set the threshold level for the pixels (e.g., possible range is 0-255 for an 8 bit solution). This threshold level can be a digital value corresponding to the reference voltage level V_{ref} discussed above with respect to FIG. 3. It should be noted that the following description refers to “ALC pixels” which correspond to the predetermined number of pixels used in method 200. It should also be noted that in the following discussion of the feedback adjustment process, signal levels of the ALC pixels are being used from the analog-to-digital converter path 915 instead of the ALC path (i.e., digital signal values are being used).

In addition, a target value (i.e., how many of the predetermined ALC pixels that should be at or above that threshold level) is also defined and stored in register 941. This target can be the required number of pixels at the predefined signal level Pᵣ discussed above with respect to method 200 if desired. For example, in an exemplary implementation, the predetermined number of ALC pixels (out of all of the pixels 122) is 640, and the target value can be 10 pixels. In addition, it is desirable to select the number of successive frames that should contain a number of pixels above/below the threshold signal level before adjusting the threshold (i.e., V_{ref}). This will be referred to herein as the “successive frames value.” In an exemplary implementation, the range for the successive frames value is between 1 and 8, but it should be understood that the invention is not limited to such a range.

This successive frames processing will have a low pass effect and reduce flickering in successive images. It should be noted that there are numerous ways to implement filter or tracking functions and that the invention is not to be limited to include these or any specific filter or tracking functions.

To explain the feedback concept, the successive frames value is chosen to be three frames. Therefore, using this example, if in three or more successive frames, more than the specified number of ALC pixels have a signal level that is above the threshold level defined in the threshold register, the voltage reference V_{ref} should be adjusted down (with a step size defined in a step size register or register 941). If, however, in three or more successive frames, less than the specified number of ALC pixels have a signal level that is above the threshold level, the voltage reference V_{ref} should be adjusted upwards. The adjustments are then carried out through the method 200 illustrated in FIG. 3 and discussed in detail above.

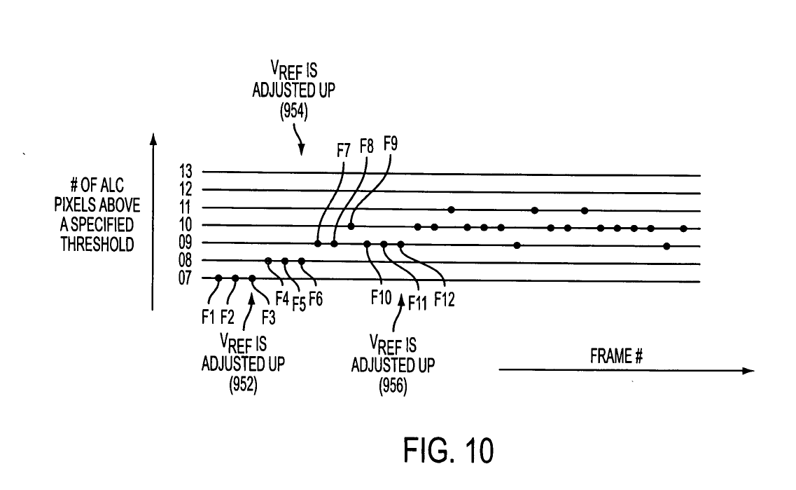

An illustration of the digital feedback adjustment used in the invention is shown in FIG. 10. In this example, the required number of ALC pixels reaching the threshold value is set at ten pixels and the number of successive frames is set to three. Looking at the readout of the first frame F1, it can be seen that only seven of the ALC pixels are above the predefined threshold. Since this is the first frame, there is no adjustment in either direction (i.e., the number of successive frames is less than the successive frame value). In the second frame F2, only seven of the ALC pixels are above the predefined threshold. Since this is only the second successive frame, there is no adjustment in either direction. For the third frame F3, there are seven ALC pixels above the predefined threshold value. Since this is the third successive frame having less than the specified ten ALC pixels above the predefined threshold signal level, the reference voltage V_{ref} parameter value is adjusted upwards (at arrow 952) by the readout and ALC feedback control logic 940 (FIG. 9).

In the next three successive frames F4, F5, F6, only eight of the ALC pixels have reached the saturation level. Accordingly, the reference voltage V_{ref} parameter value is adjusted upwards (at arrow 954) by the readout and ALC feedback control logic 940 (FIG. 9). Frames seven and eight F7, F8 have nine pixels above the threshold, but frame nine F9 has ten. As such, there is no adjustment at frame nine F9. Frames ten, eleven and twelve F10, F11, F12, however, have only nine pixels above the threshold level. As such, the reference voltage V_{ref} parameter value is adjusted upwards (at arrow 956) by the readout and ALC feedback control logic 940 (FIG. 9).

After a certain number of frames (depending on the detailed filter implementation), the reference voltage V_{ref} parameter will correspond to the desired ten (in this example) ALC pixels being at or above the specified threshold. As such, the feedback method of the invention removes uncertainties from the ALC process so that the ALC process can properly adjust the image exposure in the desired manner. It should be noted that the feedback adjustment process of the invention can be run for a desired number of frames and then stopped when the inaccuracy has been compensated for. It should also be noted that the feedback adjustment process of the invention can be continuously run to compensate for any future inaccuracies such as when the light emitting diode drops or changes in the supply voltage.

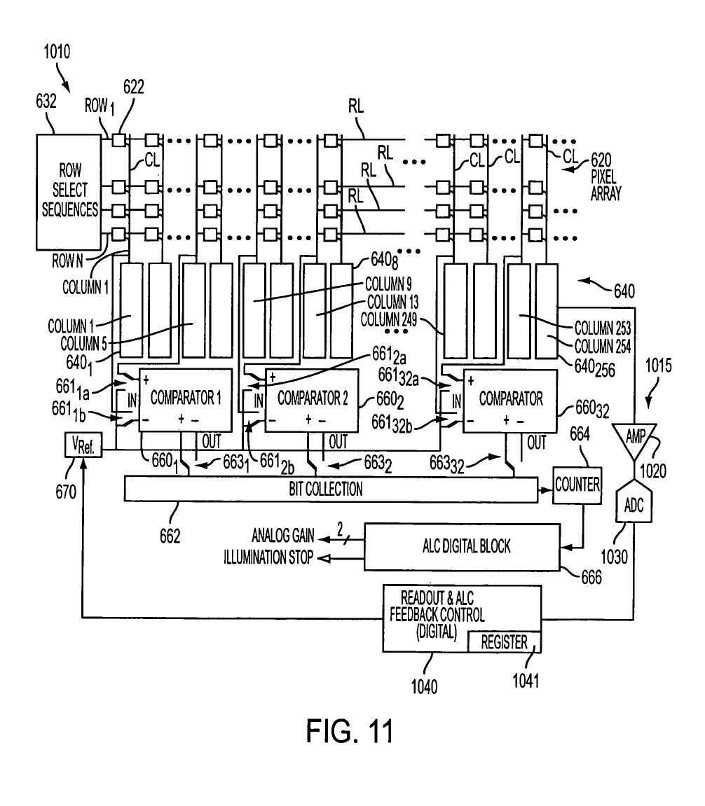

FIG. 11 illustrates another exemplary imager 1010 constructed in accordance with another embodiment of the invention. The illustrated imager 1010 utilizes digital feedback to adjust the automatic light control process of the invention. The illustrated imager 1010 is essentially the same as the imager 610 illustrated in FIG. 6 except that a digital readout and ALC feedback control block 1040 is connected to an analog-to-digital converter 1030.

The imager 1010 also includes an amplifier 1020 connected to the column circuitry 640. Although only one amplifier 1020 and analog-to-digital converter 1030 are shown in FIG. 11, it should be appreciated that there will be multiple amplifiers 1020 and ADCs 1030 (at least one per column circuit 640). The amplifiers 1020 and analog-to-digital converters 1030 comprise an analog-to-digital converter path 1015 that feeds into the digital readout and ALC feedback control block 1040. Block 1040 contains registers 1041 required to set the various parameters discussed above. The operation of the imager 1010 with respect to the use of digital feedback to adjust the ALC process is substantially the same as described above with respect to the imager 910 illustrated in FIG. 9.

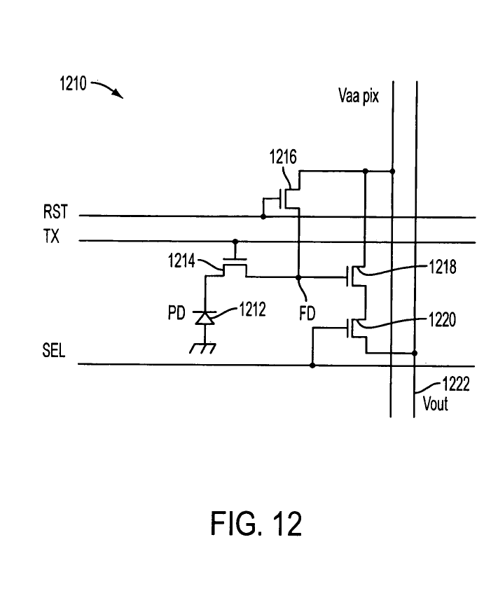

A typical four transistor (4T) CMOS imager pixel 1210 is shown in FIG. 12. The pixel 1210 includes a photosensor 1212 (e.g., photodiode, photogate, etc.), transfer transistor 1214, floating diffusion region FD, reset transistor 1216, source follower transistor 1218 and row select transistor 1220. The photosensor 1212 is connected to the floating diffusion region FD by the transfer transistor 1214 when the transfer transistor 1214 is activated by a transfer gate control signal TX.

The reset transistor 1216 is connected between the floating diffusion region FD and an array pixel supply voltage Vaa_pix. A reset control signal RST is used to activate the reset transistor 1216, which resets the floating diffusion region FD to the array pixel supply voltage Vaa_pix level as is known in the art.

The source follower transistor 1218 has its gate connected to the floating diffusion region FD and is connected between the array pixel supply voltage Vaa_pix and the row select transistor 1220. The source follower transistor 1218 converts the charge stored at the floating diffusion region FD into an electrical output voltage signal Vout. The row select transistor 1220 is controllable by a row select signal SEL for selectively connecting the source follower transistor 1218 and its output voltage signal Vout to a column line 22 of the pixel array.

It should be noted that when used with the four transistor (4T) pixel 1210, the feedback method of the invention will also compensate for any uncertainty in the photosensor/floating diffusion region ratio of the pixel 1210. In fact, in a 4T pixel 1210, the floating diffusion region FD could be used as ALC sensing node during exposure.

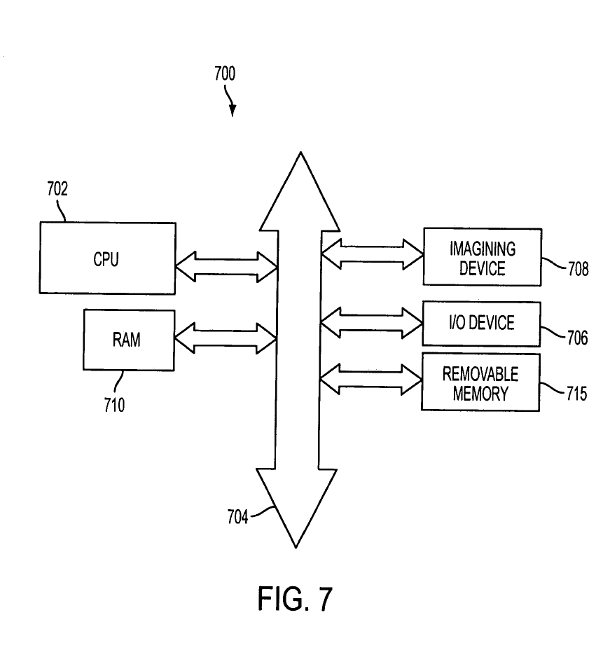

FIG. 7 shows system 700, a typical processor system modified to include an imaging device 708 constructed in accordance with an embodiment of the invention (i.e., imager 110 of FIG. 2, imager 610 of FIG. 6, imager 910 of FIG. 9, or imager 1010 of FIG. 11). The processor-based system 700 is exemplary of a system having digital circuits that could include image sensor devices. Without being limiting, such a system could include a computer system, camera system, scanner, machine vision, vehicle navigation, video phone, surveillance system, auto focus system, star tracker system, motion detection system, image stabilization system, and data compression system.

System 700, for example a camera system, generally comprises a central processing unit (CPU) 702, such as a microprocessor, that communicates with an input/output (I/O) device 706 over a bus 704. Imaging device 708 also communicates with the CPU 702 over the bus 704. The processor-based system 700 also includes random access memory (RAM) 710, and can include removable memory 715, such as flash memory, which also communicate with the CPU 702 over the bus 704. The imaging device 708 may be combined with a processor, such as a CPU, digital signal processor, or microprocessor, with or without memory storage on a single integrated circuit or on a different chip than the processor.

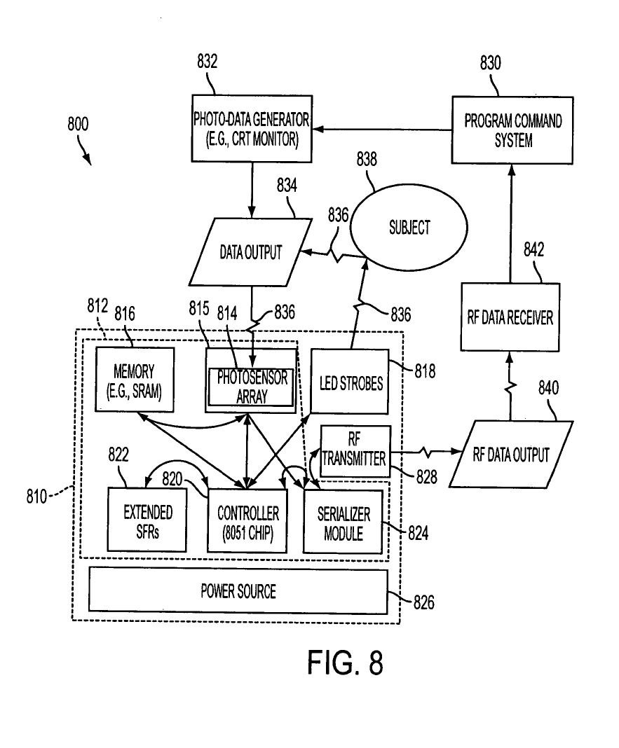

FIG. 8 shows another exemplary system 800 having a device 810 incorporating an imager chip 812 constructed in accordance with an embodiment of the invention (i.e., imager 110 of FIG. 2, imager 610 of FIG. 6, imager 910 of FIG. 9, or imager 1010 of FIG. 11). The imager chip 812 can include a photosensor array 814, photosensor interface 815, memory circuit 816, and a controller 820 integrated on the same silicon chip. The photosensor interface 815 can be controlled by the controller 820 for addressing the array 814. The system 800 is constructed and operated as described in copending U.S. application Ser. No. 10/143,578.

The memory circuit 816 can communicate with the other operational circuits of the device 810, including, but not limited to, the controller 820 (e.g., an 8051 controller), a serializer module 824, extended shift registers SFRs 822, and an RF (radio frequency) transmitter 828. The memory circuit 816 is capable of storing operational information for the photosensor array 814 and all other circuitry incorporated into the device 810. Further, the memory circuit 816 is be capable of storing images received by the photosensor array 814. The controller 820 operates as the “brain” of the device 810 using programming and/or data stored in the memory circuit 816, and/or in an internal ROM. The controller 820 can utilize the stored programs and/or data in controlling the acquiring of images, the storing of images, and the communication of images to an external system for viewing.

The CMOS photosensor array 814 can download captured images, like a camera. However, the CMOS photosensor array 814 of the invention can also download programming and/or operational information as data-input 834, such as software, programming, or other useful data. A user can select the data desired to be downloaded by utilizing a program command system 830, which can contain a collection of programs, instructions, software, or other data that can be utilized by the device 810. The program command system 830, which can be a standard computer, communicates to a photo-data generator 832, which can be any device capable of outputting light signals, for instance, a computer monitor (CRT) connected to a computer, or an LED unit. Preferably, the photo-data generator 832 can output light at various wavelengths (colors) and intensities, and in various patterns.

The photo-data generator 832 generates light 836, which is input to photosensor array 814 during a period when it is not acquiring images. This period can be controlled and designated by the controller 820. The light 836 can be varied in any means known in the art so that it corresponds to the data desired to be downloaded into the device 810. As an example, the light can be varied in color, where different colors or color patterns can be read by the photosensor array 814, stored in the memory circuit 16, and interpreted by the controller 820 of the device 810, via communication with the photosensor array 814, as different digital information (i.e., “1s” and “0s”). In this way, the memory circuit 814, and device 810 in general, can be programmed by a user with the input of light 836 to the photosensor array 814.

The device 810 functions as an imager camera. The camera function of the device 810 is like that of any other CMOS imager camera to acquire still frames or constant motion video. If necessary, the LED(s) 818 can function as light strobes during camera use, and be synchronized with the image acquisition by the photosensor array 814. Light 836 from the LED 818 can illuminate a subject 838 within an image area to be captured. The reflected light 836 from the illuminated subject 838 can be acquired by the photosensor array 814. The images acquired by the photosensor array 814 are communicated to and translated by the serializer module 824 into a format for image output.

The memory circuit 816 can store programming and/or data so that the controller 820 can use the input programs and/or data acquired during the data input operation to direct the operation of the photosensor array 814, the serializer module 824, and the extended SFRs 822 (all of which can be in communication with the memory circuit 816 and controller 820) for image capture, storage, processing, and output.

At a desired time, or on an ongoing basis, the stored images can be translated into an RF data output 840 generated by an RF transmitter 828 in communication with the serializer module 824 under control of the controller 820. The images, as RF data output 840, are transmitted to an RF data receiver 842. The RF data receiver 842 is in communication with the program command system 830 so that a user can receive the images acquired by the photosensor array 814 for viewing, for example on the same computer monitor (i.e., photo-data generator 832) that could be used to initially program the device 810. In one desired embodiment, the device 810 is incorporated into a swallowable pill as described in copending U.S. application Ser. No. 10/143,578.

The processes and devices described above illustrate preferred methods and typical devices of many that could be used and produced. The above description and drawings illustrate embodiments, which achieve the objects, features, and advantages of the present invention. However, it is not intended that the present invention be strictly limited to the above-described and illustrated embodiments. Any modification, though presently unforeseeable, of the present invention that comes within the spirit and scope of the following claims should be considered part of the present invention.

1. A method of controlling an imager comprising an array of pixels, said method comprising the acts of:
obtaining digital pixel signals from at least a set of pixels in the array;
comparing a value of each digital pixel signal to a reference level;
determining whether a target number of pixels have reached the reference level; and
adjusting at least one automatic light control parameter based on whether the target number of pixels have reached the reference level to control a light control operation of the imager.

2. The method of claim 1, wherein the automatic light control parameter is the reference level and said adjusting step lowers the reference level when the target number of pixels have exceeded the reference level.

3. The method of claim 1, wherein the automatic light control parameter is the reference level and said adjusting step raises the reference level when the target number of pixels have not reached the reference level.

4. The method of claim 1, further comprising the act of determining whether the target number of pixels have not reached the reference level for a predetermined number of successive image frames.

5. The method of claim 4, wherein the automatic light control parameter is the reference level and said adjusting step lowers the reference level when the target number of pixels have exceeded the reference level for the predetermined number of successive image frames.

6. The method of claim 4, wherein the automatic light control parameter is the reference level and said adjusting step increases the reference level when the target number of pixels have not reached the reference level for the predetermined number of successive image frames.

7. The method of claim 1, further comprising the act of repeating said obtaining act through said adjusting act for a predetermined number of image frames.

8. The method of claim 1, further comprising the act of repeating said obtaining act through said adjusting act continuously during the operation of the imager.

9. The method of claim 1, wherein the automatic light control operation comprises:
starting an exposure period;
obtaining analog pixel signals from the set of pixels in the array;
comparing a value of each analog pixel signal to the automatic light control parameter;
comparing a current exposure time to a maximum exposure time; and
adjusting at least one exposure control parameter based on said comparisons.

10. The method of claim 9, further comprising the act of ending the exposure period if the current exposure time is greater than or equal to the maximum exposure time.

11. The method of claim 9, further comprising the act of ending the exposure period if a predetermined number of pixels have a pixel signal value greater than the reference level.

12. The method of claim 9, wherein the at least one exposure control parameter is a gain value.

13. The method of claim 9, wherein the at least one exposure control parameter is the maximum exposure time.

14. The method of claim 9, wherein the at least one exposure control parameter is the reference level.

15. The method of claim 1, wherein said act of obtaining comprises the acts of:
scanning rows of pixels in the array;
inputting pixel signals from a set of columns of the array; and
converting the pixel signals to digital signals.

16. The method of claim 1, wherein the at least a set of pixels comprises less than all pixels in the array.

17. A method of operating an image sensor contained in an enclosure that has been swallowed, said method comprising the acts of:
obtaining analog pixel signals from a set of pixels in the array;
converting the analog pixel signals to digital pixel signals;
comparing a value of each digital pixel signal to a reference level;
determining whether a target number of pixels have reached the reference level; and
adjusting at least one automatic light control parameter based on whether the target number of pixels have reached the reference level to control a light control operation of the imager.

18. The method of claim 17, wherein the automatic light control parameter is the reference level and said adjusting step lowers the reference level when the target number of pixels have exceeded the reference level.

19. The method of claim 17, wherein the automatic light control parameter is the reference level and said adjusting step raises the reference level when the target number of pixels have not reached the reference level.

20. The method of claim 17, further comprising the act of determining whether the target number of pixels have not reached the reference level for a predetermined number of successive image frames.

21. The method of claim 20, wherein the automatic light control parameter is the reference level and said adjusting step lowers the reference level when the target number of pixels have exceeded the reference level for the predetermined number of successive image frames.

22. The method of claim 20, wherein the automatic light control parameter is the reference level and said adjusting step increases the reference level when the target number of pixels have not reached the reference level for the predetermined number of successive image frames.

23. The method of claim 17, further comprising the act of repeating said obtaining act through said adjusting act for a predetermined number of image frames.

24. The method of claim 17, further comprising the act of repeating said obtaining act through said adjusting act continuously during the operation of the imager.

25. The method of claim 17, wherein the automatic light control operation comprises:
starting an exposure period;
obtaining the analog pixel signals from the set of pixels in the array;
comparing a value of each analog pixel signal to the automatic light control parameter;
comparing a current exposure time to a maximum exposure time; and
adjusting at least one exposure control parameter based on said comparisons.

26. The method of claim 25, further comprising the act of ending the exposure period if the current exposure time is greater than or equal to the maximum exposure time.

27. The method of claim 25, further comprising the act of ending the exposure period if a predetermined number of pixels have a pixel signal value greater than the reference level.

28. The method of claim 25, wherein the at least one exposure control parameter is a gain value.

29. The method of claim 25, wherein the at least one exposure control parameter is the maximum exposure time.

30. The method of claim 25, wherein the at least one exposure control parameter is the reference level.

31. An image sensor comprising:
an array of pixels;
an analog-to-digital conversion path connected to a predetermined number of pixels;
a feedback circuit, connected to receive digital pixel signals from the analog-to-digital conversion path, said feedback circuit for:
comparing a value of each digital pixel signal to a reference level, determining whether a target number of pixels have reached the reference level, and adjusting at least one automatic light control parameter based on whether the target number of pixels have reached the reference level to control a light control operation of the imager.

32. The image sensor of claim 31, wherein the automatic light control parameter is the reference level, said feedback circuit for lowering the reference level when the target number of pixels have exceeded the reference level.

33. The image sensor of claim 31, wherein the automatic light control parameter is the reference level, said feedback circuit for raising the reference level when the target number of pixels have not reached the reference level.

34. The image sensor of claim 31, further comprising said feedback circuit for determining whether the target number of pixels have not reached the reference level for a predetermined number of successive image frames.

35. The image sensor of claim 34, wherein the automatic light control parameter is the reference level, said feedback circuit for lowering the reference level when the target number of pixels have exceeded the reference level for the predetermined number of successive image frames.

36. The image sensor of claim 34, wherein the automatic light control parameter is the reference level, said feedback for increasing the reference level when the target number of pixels have not reached the reference level for the predetermined number of successive image frames.

37. The image sensor of claim 31, further comprising said feedback circuit for repeating the obtaining act through the adjusting act for a predetermined number of image frames.

38. The image sensor of claim 31, further comprising said feedback circuit for repeating the obtaining act through the adjusting act continuously during the operation of the imager.

39. The image sensor of claim 31, further comprising a reference voltage generator for generating the automatic light control parameter.

40. The image sensor of claim 31, further comprising:
a plurality of comparison circuits, each comparison circuit for receiving a reference signal and being coupled to a respective column of the array, each comparison circuit comparing an analog pixel signal to the reference signal and having an output indicative of a result of the comparison;
a first circuit connected to and for counting the results output from the comparison circuits, said first circuit having a first output; and
a logic circuit connected to the first output, wherein during an exposure period said logic circuit uses the first output and a current exposure time to perform automatic light control for the exposure period.

41. The image sensor of claim 40, wherein said logic circuit adjusts at least one exposure control parameter based on the first output and current exposure time.

42. The image sensor of claim 41, wherein the at least one exposure control parameter is a gain value.

43. The image sensor of claim 41, wherein the at least one exposure control parameter is the maximum exposure time.

44. The image sensor of claim 41, wherein the at least one exposure control parameter is the reference level.

45. The image sensor of claim 41, wherein said logic circuit ends the exposure period if the current exposure time is greater than or equal to a maximum exposure time.

46. The image sensor of claim 41, wherein said logic circuit ends the exposure period if a predetermined number of pixels have a pixel signal value greater than the reference signal.

47. The image sensor of claim 31 wherein said feedback circuit is a digital feedback circuit.

48. A processor system comprising:
a processor; and
an imager communicating with said processor, said imager comprising:
an array of pixels;
an analog-to-digital conversion path connected to a predetermined number of pixels;
a feedback circuit, connected to receive digital pixel signals from the analog-to-digital conversion path, said feedback circuit for: comparing a value of each digital pixel signal to a reference level, determining whether a target number of pixels have reached the reference level, and adjusting at least one automatic light control parameter based on whether the target number of pixels have reached the reference level to control a light control operation of the imager.

49. A swallowable pill comprising:
an imager, said imager comprising:
an array of pixels;
an analog-to-digital conversion path connected to a predetermined number of pixels;
a feedback circuit, connected to receive digital pixel signals from the analog-to-digital conversion path, said feedback circuit for: comparing a value of each digital pixel signal to a reference level, determining whether a target number of pixels have reached the reference level, and adjusting at least one automatic light control parameter based on whether the target number of pixels have reached the reference level to control a light control operation of the imager.

50. The pill of claim 49, wherein the automatic light control parameter is the reference level, said feedback circuit for lowering the reference level when the target number of pixels have exceeded the reference level.

51. The pill of claim 49, wherein the automatic light control parameter is the reference level, said feedback circuit for raising the reference level when the target number of pixels have not reached the reference level.

52. The pill of claim 49, further comprising said feedback circuit for determining whether the target number of pixels have not reached the reference level for a predetermined number of successive image frames.

53. The pill of claim 52, wherein the automatic light control parameter is the reference level, said feedback circuit for lowering the reference level when the target number of pixels have exceeded the reference level for the predetermined number of successive image frames.

54. The pill of claim 52, wherein the automatic light control parameter is the reference level, said feedback circuit for increasing the reference level when the target number of pixels have not reached the reference level for the predetermined number of successive image frames.

55. The pill of claim 49, further comprising said feedback circuit for repeating the obtaining act through the adjusting act for a predetermined number of image frames.

56. The pill of claim 49, further comprising said feedback circuit for repeating the obtaining act through the adjusting act continuously during the operation of the imager.

57. The pill of claim 49, further comprising a reference voltage generator for generating the automatic light control parameter.

58. The pill of claim 49, further comprising:
a plurality of comparison circuits, each comparison circuit receiving a reference signal and being coupled to a respective column of the array, each comparison circuit comparing an analog pixel signal to the reference signal and having an output indicative of a result of the comparison;
a first circuit connected to and counting the results output from the comparison circuits, said first circuit having a first output; and
a logic circuit connected to the first output, wherein during an exposure period said logic circuit uses the first output and a current exposure time to perform automatic light control for the exposure period.

59. The pill of claim 58, wherein said logic circuit adjusts at least one exposure control parameter based on the first output and current exposure time.

60. The pill of claim 58, wherein the at least one exposure control parameter is a gain value.

61. The pill of claim 58, wherein the at least one exposure control parameter is the maximum exposure time.

62. The pill of claim 58, wherein the at least one exposure control parameter is the reference level.

63. The pill of claim 58, wherein said logic circuit ends the exposure period if the current exposure time is greater than or equal to a maximum exposure time.

64. The pill of claim 58, wherein said logic circuit ends the exposure period if a predetermined number of pixels have a pixel signal value greater than the reference signal.

65. The pill of claim 49, wherein said feedback circuit is a digital feedback circuit.

66. A swallowable pill comprising:
an image sensor, said image sensor comprising:
means for obtaining digital pixel signals from a set of pixels in the array;
means for comparing a value of each digital pixel signal to a reference level;
means for determining whether a target number of pixels have reached the reference level; and
means for adjusting at least one automatic light control parameter based on whether the target number of pixels have reached the reference level to control a light control operation of the imager.
